(19) United States
(12) Patent Application Publication
(10) Pub. No.: US 2010/0153550 A1
(43) Pub. Date: Jun. 17, 2010

(54) PLUGGABLE DEVICE THAT ENABLES AN ADDITION OF SECURITY FUNCTIONALITY IN A NETWORK

(75) Inventors: Wael William Diab, San Francisco, CA (US); Alireza Abaye, Irvine, CA (US)

Correspondence Address: LAW OFFICE OF DUANE S. KOBAYASHI, P.O. Box 4160, Leesburg, VA, 20177, US

(73) Assignee: Broadcom Corporation, Irvine, CA (US)

(21) Appl. No.: 12/335,006

(22) Filed: Dec. 15, 2008

(51) Int. Cl. G06F 15/173

(52) U.S. Cl. 709/225

(57) ABSTRACT

A pluggable device that enables an addition of security functionality in a particular network/application. In one example, MACSec functionality can be incorporated into a small form factor pluggable module. This enables new functionality to be added to a network in an incremental fashion. This results due to the inclusion of circuitry within the pluggable module that supports the new functionality.

### BACKGROUND

1. Field of the Invention

The present invention relates generally to network functionality and, more particularly, to a pluggable device that enables an addition of security functionality in a particular network/application.

2. Introduction

FIG. 1 illustrates an example of components that can support a part of a network such as an access network. The access network includes a host system 110 that supports multiple ports via media access control (MAC) chips 112-1 to 112-N. MAC chip 112-1, for example, is connected to physical layer (PHY) chip 120 via standard interface 140 such as MII, GMII, RMII, SMII, RGMII, SGMII, XGMII, etc. In this embodiment, PHY chip 120 would contain the physical coding sublayer (PCS) and physical medium attachment (PMA) sublayer. In an alternative embodiment, the PCS would be embodied in MAC chip 112-1 such that the standard interface 140 would not be exposed. As would be appreciated, other variations in distributing functionality between one or more chips can be implemented.

In the illustrated embodiment, PHY chip 120 does not include the physical medium dependent (PMD) sublayer. The PMD sublayer is implemented instead as separate PMD module 130, which is further connected to some form of physical cabling (e.g., fiber optic cabling, copper cabling, etc.). An advantage of separating the PMD from PHY chip 120 is the creation of a pluggable/removable module that can be added/removed to facilitate changes in the network.

One example of such a module is the small form-factor pluggable (SFP) module, which contains optical modular transceivers. These hot-swappable devices are designed for use with small form factor (SFF) connectors, and offer high speed and physical compactness. Since the optical components represent a dominant cost of the components for a particular access port, the access network costs can be incurred gradually (i.e., pay as you go) as the access network grows to populate the board with a full set of SFP modules. This ensures that the costs incurred are attributed to ports that are actually used. Moreover, this “pay as you go” model is advantageous since the actual split of ports between those that have the new functionality enabled versus not-enabled may not be known initially.

In an environment such as that illustrated in FIG. 1, one of the further challenges is the migration of additional functionality into the access network. These challenge exists due to the large installed base of access ports on the central office (CO) side as well as existing optical line terminations (OLTs). Upgrading the functionality of these access networks would therefore require large capital expenditure in replacing equipment to support the new functionality. What is needed therefore is a mechanism that enables low-cost migration of equipment that supports new functionality in the access network.

### SUMMARY

A pluggable device that enables an addition of security functionality in a particular network/application, substantially as shown in and/or described in connection with at least one of the figures, as set forth more completely in the claims.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered limiting of its scope, the invention will be described and explained with additional specificity and detail through the use of the accompanying drawings in which:

FIG. 1 illustrates an example embodiment of a network.

FIG. 2 illustrates an example of a pluggable module.

FIG. 3 illustrates an example of a network that adds new functionality using an enhanced pluggable module.

FIG. 4 illustrates an example of an enhanced pluggable module that incorporates MAC components.

FIG. 5 illustrates another example of an enhanced pluggable module that enables IPsec functionality.

### DETAILED DESCRIPTION

Various embodiments of the invention are discussed in detail below. While specific implementations are discussed, it should be understood that this is done for illustration purposes only. A person skilled in the relevant art will recognize that other components and configurations may be used without parting from the spirit and scope of the invention.

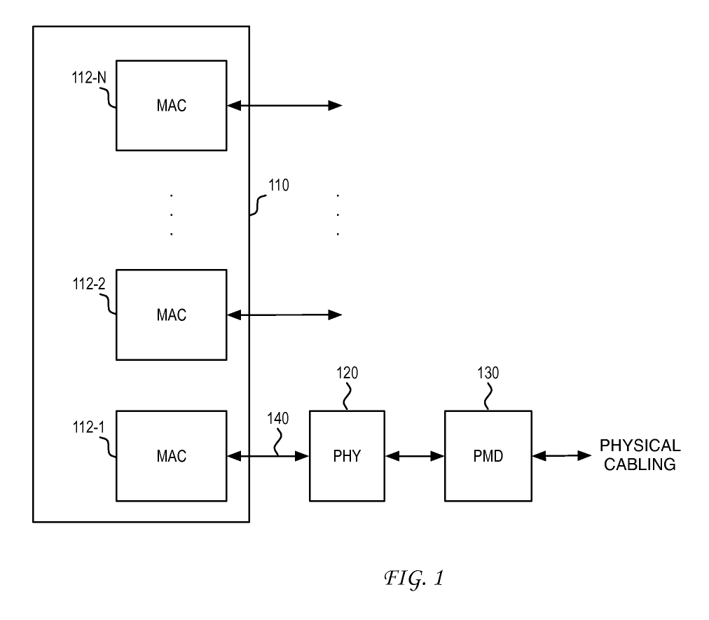

As noted, migration of new functionality into a network can result in huge capital expenditures. This results because much of the additional functionality would require changes in key components (e.g., MAC chips) of the network. For example, in the context of FIG. 1, the addition of new MAC functionality into the network would require a change of host system 110, which contains MAC chips 112-1 to 112-N.

One example of added functionality is the MACSec security project, which was originally started to add security for networks such as Ethernet passive optical networks (EPONs). Today, there are a growing number of applications for MACSec throughout the network, including the access network. Adding such MACSec functionality would require changes to the MAC chip.

In the context of the environment of FIG. 1, changes to the MAC chip would require wholesale change of host system 110. The network provider would therefore be forced to incur the cost of migrating multiple ports at once, instead of on a port-by-port basis. Ideally, system migration at this level needs to be designed ahead of time, where a predetermined split of ports that support or do not support the new functionality would need to be known. System migration after installation incurs significant expense and can be impractical from a cost/benefit perspective.

It is a feature of the present invention that new functionality (e.g., MACSec) can be added to the network without wholesale changes being required. This feature of the present invention is enabled by the recognition that many of the currently-installed base of links use some form of pluggable device. This pluggable device can be a copper pluggable module, optical pluggable module (e.g., SFP device), or the like. As will be described in greater detail below, an easy upgrade path can be enabled through the embedding of new functionality into the pluggable device. This embedded functionality into the pluggable device would further enable a variable configuration of ports in the network, thereby eliminating large, up-front capital expenditures. Instead, functionality is added on a link by link basis into the network.

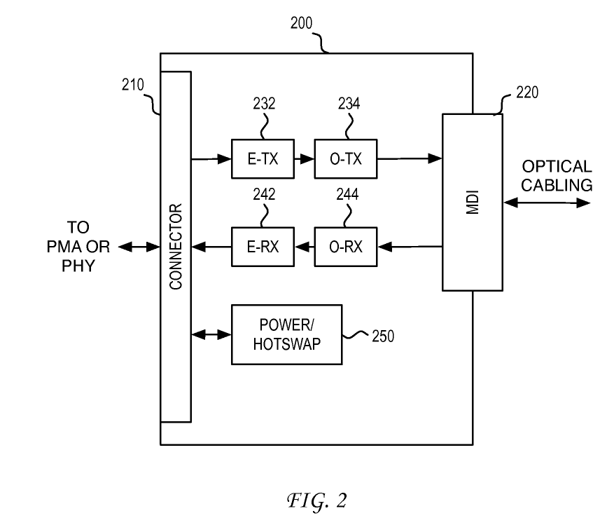

To illustrate this feature of the present invention, reference is first made to FIG. 2, which illustrates an example of a conventional optical pluggable module. As illustrated, pluggable module 200 is designed to be connected to the PMA or PHY via connector 210. Connector 210 is the interface to a host system and can be designed to allow pluggability such that the entire module can be installed and removed at once.

In the transmit direction, electrical signals from connector 210 are passed to electrical transmitter (E-TX) 232, which is coupled to optical transmitter (O-TX) 234. In turn, O-TX 234 is coupled via couplers/ferrules to medium dependent interface (MDI) 220, which supports the optical cabling. Similarly, in the receive direction, optical signals received from MDI 220 are passed to optical receiver (O-RX) 244, which is coupled to electrical receiver (E-RX) 242. In turn, E-RX 242 is coupled to connector 210, which serves to pass received signals to the PMA or PHY. As further illustrated in FIG. 2, pluggable module 200 also includes power/hotswap circuitry 250, which enables pluggable module 200 to be hotswapped in the field.

As noted, a disadvantage of conventional networks is the difficulty in adding new functionality to the links. Typically, this difficulty is due to the costs of replacing boards containing a plurality of PHY and/or MAC chips that support a plurality of ports. In the present invention, new functionality can be added on a pay-as-you-go basis into the network through the incorporation of such added functionality into pluggable components. In effect, it is a feature of the present invention that pluggable components can be leveraged as a new vehicle for adding functionality into the network.

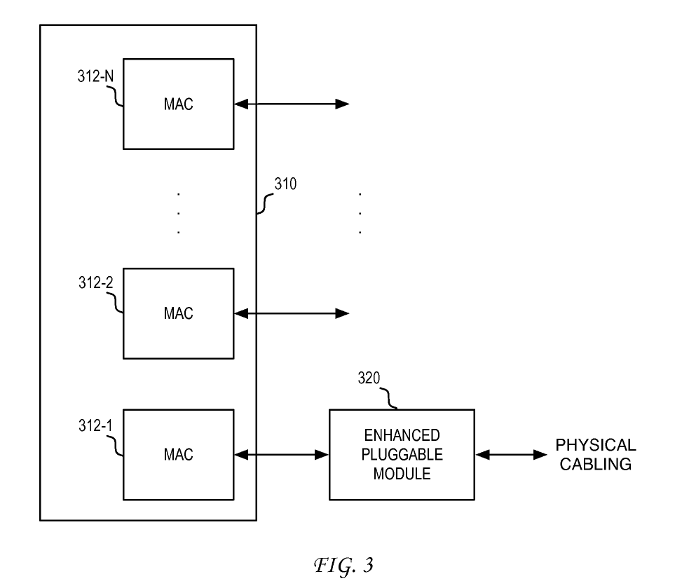

FIG. 3 illustrates an example embodiment of a network that enables such a pluggable component. As illustrated, the network includes a host system 310 that supports multiple ports via MAC chips 312-1 to 312-N. In this example, MAC chip 312-1 is connected to enhanced pluggable module 320, which incorporates PHY/MAC components that add new functionality into the network. In one example, enhanced pluggable module 320 enables new functionality such as synchronous Ethernet. By the inclusion of an enhanced PHY into the enhanced pluggable module 320, synchronous Ethernet functionality can be added on a port-by-port basis, as distinct from other ports that are supported by standard PHYs.

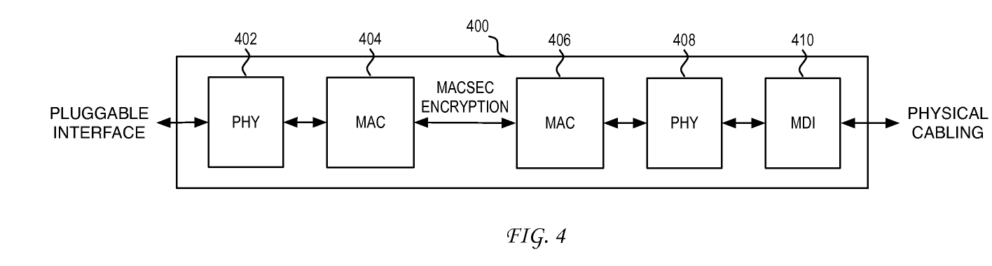

FIG. 4 illustrates an example of an enhanced pluggable module that incorporates new Layer 2 functionality, such as MACsec functionality. As illustrated, enhanced pluggable module 400 is designed to be coupled to a pluggable interface in a chip in a host system. This enhanced pluggable module further supports a particular physical cabling (e.g., optical cabling) via MDI 420.

The specification of the pluggable interface in the chip in the host system would be dependent on the particular implementation. In one embodiment, the chip supporting the pluggable interface can include a serializer/deserializer (SerDes) and/or a MAC. For gigabit applications, SerDes is the PMA function that converts between a ten bit interface (TBI) and serial. A serial gigabit interface can therefore be used for gigabit modules such as SFP and gigabit interface converter (GBIC). For 10 G, the pluggable interface can support the 10 Gigabit Attachment Unit Interface (XAUI) and XFI (a 10 gigabit per second chip-to-chip electrical interface specification) for modules like XENPAK, XPAK, SFP+, etc.

Conventionally, adding new Layer 2 functionality into the network would require replacement of the host system boards that contained the MAC chips. In the present invention, new Layer 2 functionality can be added to the network through the inclusion of MAC functionality into enhanced pluggable module 400. As illustrated, this new MAC functionality is supported by MAC modules 404 and 406, which are designed to support two PHY/MAC interfaces within enhanced pluggable module 400.

One of the PHY/MAC interfaces in enhanced pluggable module 400 is between PHY 402 and MAC 404. A second PHY/MAC interface in enhanced pluggable module 400 is between MAC 406 and PHY 408. Between these two PHY/MAC interfaces resides the implementation of the added Layer 2 functionality. As illustrated in FIG. 4, an example of such a Layer 2 functionality is represented by MACSec encryption, which occurs between the two PHY/MAC interfaces. With this framework, new Layer 2 functionality can be introduced to the port, while retaining conventional connectivity of enhanced pluggable module 400 to the MAC chip in the host system. By this design, new Layer 2 functionality can be added to the network on a port-by-port basis.

While the above description has focused on the example of adding MACsec functionality, it should be noted that other MAC or bridging functionality could also be introduced by the enhanced pluggable module. For example, the principles of the present invention can be used in devices such as media converters and 2-port MAC relays.

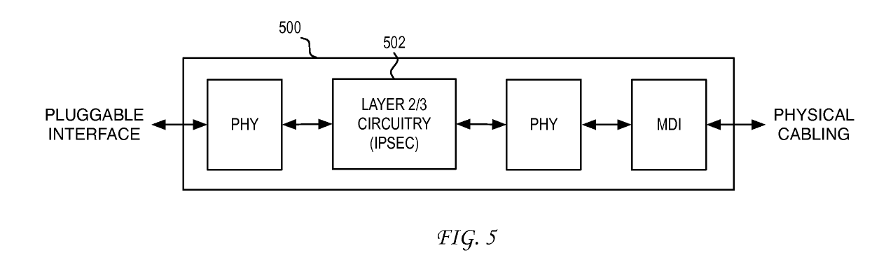

In an additional embodiment, other higher-layer functionality can be added into the network via an enhanced pluggable module. For example, IPsec functionality that secures IP communications by authenticating and encrypting IP packets can be added to the network via an enhanced pluggable module. As illustrated in FIG. 5, enhanced pluggable module 500 includes Layer 2/Layer 3 module 502, which is designed to add the logic necessary to support inspection and encryption of an IP packet. As would be appreciated, this encryption would only be done at the data origin and not on every hop of the network.

As has been described, a pluggable module has been described that enables new functionality to be added to a network (e.g., access, enterprise, etc.) in an incremental fashion. This results due to the inclusion of circuitry within the pluggable module that supports the new functionality. This is in contrast to existing pluggable modules that are designed to support primarily the interface for the particular cabling that is attached to the pluggable module.

It should be noted that the principles of the present invention outlined above can be applied to various types of pluggable modules (e.g., copper, optical, etc.). The principles of the present invention can also be applied to different standard or non-standard network speeds (e.g., 1 G, 2.5 G, 10 G, 40 G, 100 G, etc.), and various point-to-point (e.g., Ethernet, non-Ethernet, etc.) and point-to-multipoint networks (e.g., PON, EPON, EPON, 10GEPON, etc.). The principles of the present invention can also be applied to synchronous Ethernet, symmetric and asymmetric links, full and half duplex, audio-video bridging, Energy Efficient Ethernet, Power over Ethernet, etc. Additionally, the principles of the present invention can be applied to modules that support various cable types, such as copper cabling or optical cabling. In one example, the principles of the present invention can be applied to a pluggable module that supports Broad Reach Ethernet connections of greater than 100 meters (e.g., 100-500 meters). Finally, the principles of the present invention can be used in various devices such as routers, switches, servers, stackables, blades, computing devices with networking interfaces, etc.

These and other aspects of the present invention will become apparent to those skilled in the art by a review of the preceding detailed description. Although a number of salient features of the present invention have been described above, the invention is capable of other embodiments and of being practiced and carried out in various ways that would be apparent to one of ordinary skill in the art after reading the disclosed invention, therefore the above description should not be considered to be exclusive of these other embodiments. Also, it is to be understood that the phraseology and terminology employed herein are for the purposes of description and should not be regarded as limiting.

What is claimed is:

1. A pluggable module that introduces additional functionality into a network, comprising:
a media dependent interface that is designed for coupling to a physical cable;
a first interface between a first media access control component and a first physical layer component, said first physical layer component being connected to said media dependent interface; and
a second interface between a second media access control component and a second physical layer component, said second physical layer component exposing an external interface of the pluggable module that enables coupling of the pluggable module to an external system, wherein media access control components between said first interface and said second interface include support for said additional functionality.

2. The pluggable module of claim 1, wherein said additional functionality is MACSec functionality.

3. The pluggable module of claim 1, wherein said additional functionality is bridging functionality.

4. The pluggable module of claim 1, wherein said physical cable is a copper cable.

5. The pluggable module of claim 4, wherein said first physical layer component is a broad reach component that supports Ethernet connections over 100 meters.

6. The pluggable module of claim 1, wherein said physical cable is an optical cable.

7. The pluggable module of claim 1, wherein said pluggable module has one of a small form factor pluggable module, gigabit interface converter, XENPAK, or X2 form factor.

8. The pluggable module of claim 1, wherein said pluggable module interfaces with a MAC chip in said external system.

9. The pluggable module of claim 1, wherein said pluggable module interfaces with a serializer/deserializer in said external system.

10. A pluggable module that introduces security functionality into a network, comprising:
a media dependent interface that is designed for coupling to a physical cable;
a first physical layer component that is connected to said media dependent interface;
a media access control component connected to said first physical layer component, said media access control component implementing the security functionality; and
a second physical layer component connected to said media access control component, said second physical layer component exposing an external interface of the pluggable module that enables coupling of the pluggable module to an external system.

11. The pluggable module of claim 10, wherein said security functionality is MACSec functionality.

12. The pluggable module of claim 10, wherein said physical cable is a copper cable.

13. The pluggable module of claim 12, wherein said first physical layer component is a broad reach component that supports Ethernet connections over 100 meters.

14. The pluggable module of claim 10, wherein said physical cable is an optical cable.

15. The pluggable module of claim 10, wherein said pluggable module has one of a small form factor pluggable module, gigabit interface converter, XENPAK, or X2 form factor.

16. The pluggable module of claim 10, wherein said pluggable module interfaces with a MAC chip in said external system.

17. The pluggable module of claim 10, wherein said pluggable module interfaces with a serializer/deserializer in said external system.

18. A pluggable module that introduces security functionality into a network, comprising:
a media dependent interface that is designed for coupling to a physical cable;
a first physical layer component that is connected to said media dependent interface;
a security component that receives a data stream via said first physical layer component and that applies a security function to said received data stream to produce a secured data stream; and
a second physical layer component exposing an external interface of the pluggable module that enables coupling of the pluggable module to an external system, said second physical layer component delivering data based on said secured data stream to said external system.

19. The pluggable module of claim 18, wherein said secure component implement MACsec functionality.

20. The pluggable module of claim 18, wherein said secure component implement IPsec functionality.
